(19) United States
(12) Patent Application Publication
(10) Pub. No.: US 2026/0278519 A1
(43) Pub. Date: Sep. 17, 2026

(54) INFORMATION PROCESSING SYSTEM, INFORMATION PROCESSING DEVICE, INFORMATION PROCESSING METHOD, AND PROGRAM

(71) Applicant: AERONEXT INC., Tokyo (JP)

(72) Inventors: Shuji KAWAI, Tokyo (JP); Tadanari HIGUCHI, Gifu (JP); Keisuke TOJI, Tokyo (JP); Takuya HORI, Tokyo (JP)

(21) Appl. No.: 18/878,905

(22) PCT Filed: Jun. 28, 2023
(86) PCT No.: PCT/JP2023/024016

§ 371 Date: Dec. 26, 2024

(30) Foreign Application Priority Data
Jun. 30, 2022 (JP) 2022-105540

(51) Int. Cl. G06Q 10/0833; G01C 21/34

(52) U.S. Cl. CPC G06Q 10/0833; G01C 21/3423

(57) ABSTRACT

An information processing system includes: an acquisition unit that acquires location information related to a delivery person; and a setting unit that sets, based on the location information acquired by the acquisition unit, a receiving location indicating a location where the delivery person receives a transportation target from a first mobile body that relay-transports the transportation target.

### FIELD

The present invention relates to an information processing system, an information processing device, an information processing method, and a program.

### BACKGROUND

In recent years, technologies have been developed in regard to delivery work for delivery or collection of packages requested by a certain user, which enables a delivery person responding to the delivery work to efficiently deliver or collect the packages. For example, Patent Literature 1 discloses a technique that acquires the loading capacity of each of one or a plurality of circulation services circulating through three bases, and determines whether to change the operation plan of the circulation services based on the acquired loading capacity.

### CITATION LIST

### Patent Literature

Patent Literature 1: Japanese Patent Application Laid-open No. 2020-52525

### SUMMARY

### Technical Problem

However, the technology described in Patent Literature 1 increases or decreases the number of circulation services in accordance with the loading capacity, and does not take into account the delivery efficiency by cooperating with other mobile bodies, for example.

The present invention is designed in view of the aforementioned circumstances, and it is an object thereof to provide a new and improved information processing system, information processing device, information processing method, and program capable of further improving the delivery efficiency of the delivery person.

### Solution to Problem

In order to overcome such issues, one aspect of the present invention provides an information processing system including: an acquisition unit that acquires location information related to a delivery person; and a setting unit that sets, based on the location information acquired by the acquisition unit, a receiving location indicating a location where the delivery person receives a transportation target from a first mobile body that relay-transports the transportation target.

Furthermore, in order to overcome such issues, another aspect of the present invention provides an information processing device including: an acquisition unit that acquires location information related to a delivery person; and a setting unit that sets, based on the location information acquired by the acquisition unit, a receiving location indicating a location where the delivery person receives a transportation target from a first mobile body that relay-transports the transportation target.

In order to overcome such issues, still another aspect of the present invention provides an information processing method executed by a computer, the information processing method including: acquiring location information related to a delivery person; and setting, based on the acquired location information, a receiving location indicating a location where the delivery person receives a transportation target from a first mobile body that relay-transports the transportation target.

In order to overcome such issues, yet another aspect of the present invention provides a program causing a computer to execute: an acquisition function that acquires location information related to a delivery person; and a setting function that sets, based on the location information acquired by the acquisition function, a receiving location indicating a location where the delivery person receives a transportation target from a first mobile body that relay-transports the transportation target.

### Advantageous Effects of Invention

As described above, it is possible with the present invention to further improve the delivery efficiency of the delivery person.

### BRIEF DESCRIPTION OF DRAWINGS

FIG. 1 is an explanatory diagram for describing an overview of an information processing system according to an embodiment.

FIG. 2 is an explanatory diagram for describing an example of delivery slots according to the present embodiment.

FIG. 3 is an explanatory diagram for describing an example of a functional configuration of an information terminal 20 according to the present embodiment.

FIG. 4 is an explanatory diagram for describing an example of a functional configuration of an operation management server 30 according to the present embodiment.

FIG. 5 is an explanatory diagram for describing an example of a functional configuration of a schedule management server 40 according to the present embodiment.

FIG. 6 is an explanatory diagram for describing an overview related to setting of package receiving locations.

FIG. 7 is an explanatory diagram for describing an example related to setting of package receiving locations.

FIG. 8 is an explanatory diagram for describing an example of a case where another delivery person U3 relay-transports a package L.

FIG. 9 is an explanatory diagram for describing another example of a case where an unmanned vehicle 10B and another delivery person U3 relay-transport a package L.

FIG. 10 is an explanatory diagram for describing an example of operation processing of the operation management server 30 according to the present embodiment.

FIG. 11 is an explanatory diagram for describing an example of a hardware configuration of the operation management server 30 according to the present embodiment.

### DESCRIPTION OF EMBODIMENTS

The contents of an embodiment of the present invention will be listed and described. An information processing system and the like according to the embodiment has the following configurations.

### [Item 1]

An information processing system including:
an acquisition unit that acquires location information related to a delivery person; and
a setting unit that sets, based on the location information acquired by the acquisition unit, a receiving location indicating a location where the delivery person receives a transportation target from a first mobile body that relay-transports the transportation target.

### [Item 2]

The information processing system according to item 1, in which the transportation target is delivered by the delivery person using a second mobile body.

### [Item 3]

The information processing system according to item 1 or 2, in which
a delivery area of the delivery person includes a plurality of relay locations, and
the setting unit sets one relay location among the relay locations as the receiving location.

### [Item 4]

The information processing system according to item 3, in which
the location information includes a location of the delivery person, and
the setting unit sets, as the receiving location, a relay location that satisfies a prescribed condition with respect to the location of the delivery person.

### [Item 5]

The information processing system according to item 4, in which the setting unit sets the receiving location based on the location of the delivery person and a delivery route of the delivery person.

### [Item 6]

The information processing system according to item 1 or 2, in which
the location information includes a next scheduled delivery location of the delivery person, and
the setting unit sets, as the receiving location, a relay location that satisfies a prescribed condition with respect to the next scheduled delivery location of the delivery person.

### [Item 7]

The information processing system according to item 1 or 2, in which
the location information includes a relay location designated by the delivery person, and
the setting unit sets, as the receiving location, the relay location designated by the delivery person.

### [Item 8]

The information processing system according to item 6, in which the relay location that satisfies the prescribed condition includes a closest relay location.

### [Item 9]

The information processing system according to item 2, in which the first mobile body includes a vehicle or an aircraft.

### [Item 10]

The information processing system according to item 9, in which the first mobile body includes a vehicle that is used by another delivery person.

### [Item 11]

The information processing system according to item 10, in which the second mobile body includes a vehicle.

### [Item 12]

The information processing system according to item 10 or 11, in which the setting unit sets, as the receiving location, an intermediate point between the delivery person and the other delivery person.

### [Item 13]

The information processing system according to item 10 or 11, in which the setting unit sets, as the receiving location, a relay location closest to an intermediate point.

### [Item 14]

The information processing system according to item 10 or 11, in which the setting unit sets the receiving location in accordance with types of mobile bodies used by the delivery person and the other delivery person.

### [Item 15]

The information processing system according to item 1 or 2, further including a generation unit that generates delivery instruction information based on the receiving location set by the setting unit.

### [Item 16]

The information processing system according to item 15, further including a communication unit that transmits the delivery instruction information generated by the generation unit to an external device.

### [Item 17]

The information processing system according to item 16, in which, when a prescribed demand is included in request details included in a delivery request of the transportation target, the communication unit transmits notification information corresponding to the prescribed demand to a terminal used by the delivery person.

### [Item 18]

An information processing device including:
an acquisition unit that acquires location information related to a delivery person; and
a setting unit that sets, based on the location information acquired by the acquisition unit, a receiving location indicating a location where the delivery person receives a transportation target from a first mobile body that relay-transports the transportation target.

### [Item 19]

An information processing method executed by a computer, the information processing method including:
acquiring location information related to a delivery person; and
setting, based on the acquired location information, a receiving location indicating a location where the delivery person receives a transportation target from a first mobile body that relay-transports the transportation target.

### [Item 20]

A program causing a computer to execute:
an acquisition function that acquires location information related to a delivery person; and
a setting function that sets, based on the location information acquired by the acquisition function, a receiving location indicating a location where the delivery person receives a transportation target from a first mobile body that relay-transports the transportation target.

Hereinafter, a preferable embodiment of the present invention will be described in detail with reference to the accompanying drawings. In the present specification and drawings, duplicate explanations of structural components having substantially identical functional configuration will be omitted by applying the same reference signs thereto.

Furthermore, in the present specification and drawings, mobile bodies used by delivery persons are distinguished as necessary into each mobile body, such as a manned mobile body 10A and an unmanned vehicle 10B that moves under autonomous control or by remote control. However, when there is no particular need to distinguish the mobile bodies, each mobile body is simply referred to as a mobile body 10. Also, information terminals are distinguished as necessary into each information terminal, such as a delivery person terminal 20A that is used by a delivery person who delivers or collects packages and a client terminal 20B that is used by a client who makes a request for delivery or collection of packages. However, when there is no particular need to distinguish the information terminals, each information terminal is simply referred to as an information terminal 20.

### 1. Overview of Information Processing System

One embodiment of the present invention relates to an information processing system that can further improve the delivery efficiency of the delivery person regarding delivery or collection of packages.

### <1.1. Overview>

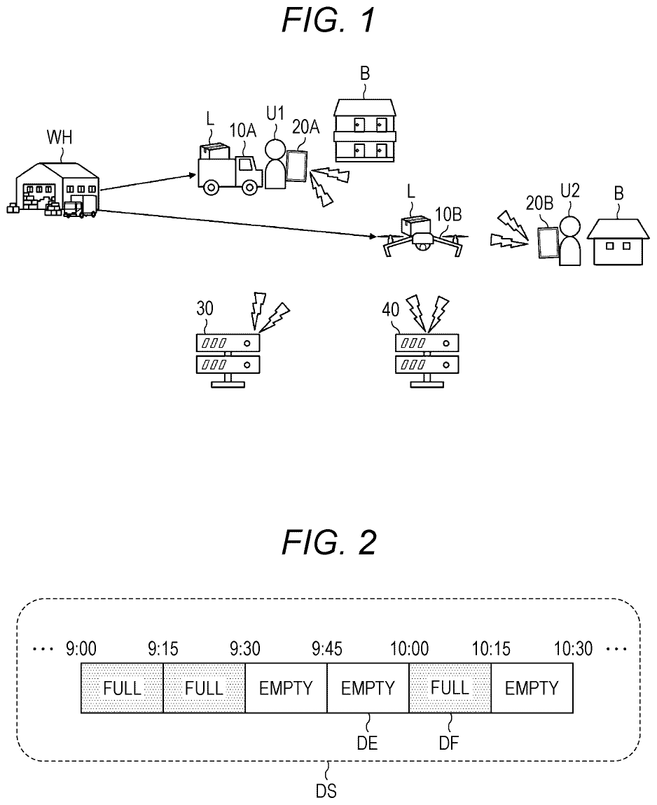

FIG. 1 is an explanatory diagram for describing an overview of the information processing system according to the present embodiment. As illustrated in FIG. 1, for example, the information processing system according to the present embodiment includes mobile bodies 10, information terminals 20, an operation management server 30, and a schedule management server 40.

The mobile bodies 10, the information terminals 20, the operation management server 30, and the schedule management server 40 are connected to each other via a network.

Although a case where a transportation target is a package L is mainly described in the following description, the transportation target according to the present embodiment is not limited to the package L. For example, the transportation target is not limited to an article such as the package L, but may also be a living organism such as a person or animal, for example.

### (Mobile Body 10)

The mobile body 10 according to the present embodiment is an example of a first mobile body and a second mobile body, and it is a mobile body used in delivery work such as delivery or collection of the package L, for example. For example, the mobile body 10 is used when delivering the package L requested to be delivered by a client U2 from a warehouse WH where the package L is stored. Note that the mobile body 10 is not essential in the delivery work, and the delivery may be made on foot along with a cart (for example, a box cart, a basket cart, or the like), for example.

For example, the mobile body 10 includes a manned mobile body 10A used by a delivery person Ul who delivers or collects the package L.

For example, the manned mobile body 10A according to the present embodiment may be a vehicle (for example, a passenger car, a light truck, a cargo vehicle such as a light van, a motorcycle, a bicycle, a kickboard, or the like) that travels on a land route, as illustrated in FIG. 1. However, the manned mobile body 10A is not limited to a vehicle. For example, the manned mobile body 10A may be an aircraft that flies on an air route, or a vessel moving along a waterway such as a seaway or a river.

Furthermore, the mobile body 10 according to the present embodiment includes an unmanned vehicle 10B that moves under autonomous control or by remote control. For example, the unmanned vehicle 10B may move by autonomous control using input information such as locations of two points such as a start point (for example, the delivery start location of the package L or the moving start location of the unmanned vehicle 10B) and an end point (for example, the receiving location of the package L), or locations of three or more points further including a relay point (for example, the collection location of the package L in the case of delivery involving collection of the package L) and a return point (for example, the same location as the moving start location of the unmanned vehicle 10, or a different standby location and the like). Note that the input information used for autonomous control may include various kinds of information such as other via points and delivery routes.

The unmanned vehicle 10B may also be moved by remote control using operation information remotely input by an administrator who manages the unmanned vehicle 10B.

For example, the unmanned vehicle 10B may be an aircraft as illustrated in FIG. 1. For example, the aircraft may be a drone that flies under autonomous control or an unmanned aerial vehicle (UAV) that flies under remote control of an administrator.

The unmanned vehicle 10B according to the present embodiment is not limited to an aircraft. For example, the unmanned vehicle 10B may be an unmanned ground vehicle (UGV) or the like that travels on a land route, or it may be a vessel traveling on a waterway, such as a seaway or a river.

The manned mobile body 10A and the unmanned vehicle 10B may also be mobile bodies that can travel on at least two or more routes out of land route, waterway, and air route.

### (Information Terminal 20)

The information terminal 20 according to the present embodiment is a terminal used by parties involved in services related to delivery and collection. For example, the information terminal 20 may be any of various kinds of terminals such as a tablet terminal, a smartphone, a cellular phone, a personal handy-phone system (PHS), a personal digital assistant (PDA), a personal computer (PC), or the like.

For example, the information terminal 20 includes a delivery person terminal 20A used by the delivery person Ul who delivers or collects the package L. For example, the delivery person Ul may use the delivery person terminal 20A to check delivery instruction information including a delivery task based on the request details included in a delivery request registered by the client U2. In FIG. 1, the package L is delivered to the client U2 who makes the delivery request. However, it is not limited to such cases, and it may also be a package that is sent by a client as a sender and delivered to a recipient different from that client. In such a case, the delivery person Ul loads the package L onto the mobile body 10 or the like when leaving the warehouse WH or the like, and one or more delivery tasks may also be set in advance as a delivery plan in a prescribed order.

The information terminal 20 also includes a client terminal 20B that is used by the client U2 who requests delivery or collection of the package L. For example, the client U2 may use the client terminal 20B to register a delivery request for delivery or collection of the package L.

### (Operation Management Server 30)

The operation management server 30 according to the present embodiment is an example of the information processing device, and it is a server that manages the operation of the mobile body 10. For example, the operation management server 30 may be a general-purpose computer such as a workstation or a PC, or may also be a cloud server.

For example, the operation management server 30 acquires location information related to the delivery person Ul and, based on the location information, sets a receiving location that indicates a location where the delivery person Ul receives the package L from the mobile body 10 that relay-transports the package L.

### (Schedule Management Server 40)

The schedule management server 40 according to the present embodiment is a server that manages various kinds of schedules related to delivery and collection. For example, the schedule management server 40 may be a general-purpose computer such as a workstation or a personal computer, or may also be a cloud server.

For example, the schedule management server 40 manages delivery plans and delivery schedules related to delivery or collection for the delivery person U1. The schedule management server 40 also manages delivery plans and delivery schedules related to delivery or collection for the unmanned vehicle 10B.

For example, when a delivery request of the package L is registered by the client U2, the schedule management server 40 may register the delivery schedule related to the delivery or collection of the package L in a delivery slot of the delivery plan of the delivery person Ul or the unmanned vehicle 10B delivering the package L.

Note that a delivery slot is the time slot in which the unmanned vehicle 10B or the delivery person Ul responds to a delivery request. For example, a daily delivery plan of the unmanned vehicle 10B (or the delivery person U1) is divided into prescribed delivery slots (for example, 15 minutes, 30 minutes, or the like for the unmanned vehicle, 1 hour or the like for the delivery person), and the unmanned vehicle 10B (or the delivery person U1) responds to, during the time corresponding to the delivery slot, the delivery of the package L registered for each delivery slot. Although not limited thereto, packages for one or two destinations may be registered in the delivery slot of the unmanned vehicle, for example, and packages for many destinations such as five to ten destinations may be registered in the delivery slot of the delivery person, for example.

FIG. 2 is an explanatory diagram for describing an example of the delivery slots according to the present embodiment. For example, a daily delivery plan DS of the unmanned vehicle 10B (or the delivery person) is divided into prescribed delivery slots (for example, 15 minutes), and the unmanned vehicle 10B (or the delivery person) delivers, during the time corresponding to the delivery slot, the package L registered for each delivery slot. Such a combination of the delivery plan DS and the delivery slots may be set for each of a plurality of receiving location candidates.

For example, a delivery plan DS set at a certain receiving location (for example, a relay location S1 or the like illustrated in FIG. 6) has two kinds that are: “full” delivery slot (referred to as “full slot DF” hereinafter) indicating that the delivery schedule of the unmanned vehicle 10B (or the delivery person) is already filled; and “empty” delivery slot (referred to as “empty slot DE” hereinafter) indicating that there is an available space in the delivery schedule of the unmanned vehicle 10B (or the delivery person).

The overview of the information processing system according to the present embodiment is described heretofore. Subsequently, examples of the functional configurations of the information terminal 20, the operation management server 30, and the schedule management server 40 according to the present embodiment will be described.

### <1.2. Example of Functional Configuration of Information Terminal 20>

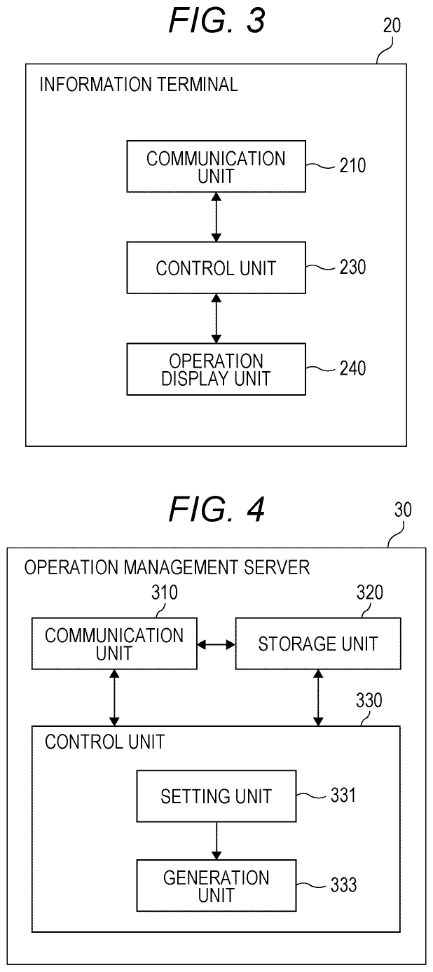

FIG. 3 is an explanatory diagram for describing an example of the functional configuration of the information terminal 20 according to the present embodiment. As illustrated in FIG. 3, the information terminal 20 according to the present embodiment includes a communication unit 210, a control unit 230, and an operation display unit 240.

### (Communication Unit 210)

The communication unit 210 according to the present embodiment performs various kinds of communication with the operation management server 30 and the schedule management server 40. For example, the communication unit 210 provided to the client terminal 20B may transmit a delivery request for delivery or collection of a package registered by the client to the operation management server 30.

The communication unit 210 provided to the delivery person terminal 20A may also transmit location information indicating the location of the delivery person terminal 20A to the operation management server 30. For example, location information indicating the location of the delivery person terminal 20A includes, for example, positioning information (information regarding longitude, latitude, and altitude) acquired by Global Navigation Satellite System (GNSS). The location information indicating the location of the delivery person terminal 20A may also be location information (for example, current address) that is directly input by the delivery person using the operation display unit 240 described later.

Furthermore, the communication unit 210 provided to the delivery person terminal 20A may receive other delivery instruction information regarding delivery of a package from the operation management server 30.

### (Control Unit 230)

The control unit 230 according to the present embodiment controls the overall operation of the information terminal 20. For example, the control unit 230 controls transmission and reception of various kinds of information performed by the communication unit 210. For example, the control unit 230 provided to the client terminal 20B may perform control to cause the communication unit 210 to transmit a delivery request including the request details input via the operation display unit 240.

The control unit 230 may also perform control to display delivery instruction information received from the operation management server 30 on the operation display unit 240. For example, the control unit 230 provided to the delivery person terminal 20A may also perform control to display other delivery instruction information received from the operation management server 30 on the operation display unit 240.

### (Operation Display Unit 240)

The operation display unit 240 according to the present embodiment has a function as an operation unit for inputting the request details related to delivery or collection of a package. The operation display unit 240 also has a function as a display unit for displaying delivery instruction information received from the operation management server 30.

The function as the operation unit can be achieved, for example, by a touch panel or a keyboard. Furthermore, the function as the display unit can be achieved by a cathode ray tube (CRT) display device, a liquid crystal display (LCD), or an organic light emitting diode (OLED) device. Note that the function as the display unit and the function as the operation unit may be configured separately.

The information terminal 20 may include a microphone. In that case, the client may use the microphone to voice-input the request details regarding delivery or collection of a package. The information terminal 20 may also include a speaker. In that case, the delivery person may check the delivery instruction information by the voice output from the speaker.

### <1.3. Example of Functional Configuration of Operation Management Server 30>

FIG. 4 is an explanatory diagram for describing an example of the functional configuration of the operation management server 30 according to the present embodiment. The operation management server 30 according to the present embodiment includes a communication unit 310, a storage unit 320, and a control unit 330, as illustrated in FIG. 4.

### (Communication Unit 310)

The communication unit 310 according to the present embodiment performs various kinds of communication with the information terminal 20 and the schedule management server 40. For example, the communication unit 310 may receive a delivery request for delivery or collection of a package registered by the client from the client terminal 20B.

Furthermore, the communication unit 310 is an example of an acquisition unit, and may receive location information related to the delivery person. For example, the communication unit 310 may receive location information indicating the location of the delivery person terminal 20A from the delivery person terminal 20A. The communication unit 310 may also receive location information based on the delivery plan of the delivery person from the schedule management server 40.

The communication unit 310 may also transmit the delivery instruction information generated by a generation unit 333 described later to an external device such as the information terminal 20, the unmanned vehicle 10B, or the like.

Furthermore, when a prescribed demand is included in the request details included in the delivery request of the client, the communication unit 310 may transmit notification information corresponding to the prescribed demand to the delivery person terminal 20A. A prescribed demand herein includes, for example, urgent delivery or the like. For example, when urgent delivery is included in the request details, the communication unit 310 may transmit notification information to the delivery person terminal 20A for warning that the delivery is urgent.

### (Storage Unit 320)

The storage unit 320 according to the present embodiment holds software and various kinds of data. For example, the storage unit 320 may hold client information. Note here that the client information may include, for example, various kinds of basic information such as the name of the client, the client name within the service, e-mail address, address, or telephone number, or it may include one or more kinds of information from identification information (ID) of the client, account information of an external application, and information regarding the package receiving location. However, client information is not limited thereto.

Furthermore, the storage unit 320 may also hold delivery person information. Note here that the delivery person information may include, for example, the basic information of the delivery person such as the name of the delivery person, e-mail address, and telephone number, may include identification information of the delivery person, current location information, current delivery area, mobile body type identification information, and the like, and may include the name of the delivery company and delivery company identification information. The delivery person information may also include, for example, external application account information, desired delivery area, identification information (including driver's license information), transfer account information, and delivery history information, and the like. However, the delivery person information is not limited thereto.

Furthermore, the storage unit 320 may also hold store information. For example, store information may include basic information of the store such as store name, business hours, address, contact information, phone number, store URL, shipping charges, and the like. The store information may also include information regarding the products, such as product names, product identification information, product corresponding storage container type information, weight information, and controlled temperature zone information, and the like. However, the store information is not limited thereto.

(control Unit 330)

The control unit 330 according to the present embodiment controls the overall operation of the operation management server 30. As illustrated in FIG. 4, for example, the control unit 330 includes a setting unit 331 and a generation unit 333.

Based on the acquired location information related to the delivery person, the setting unit 331 according to the present embodiment sets a receiving location indicating the location where the delivery person receives the package from the mobile body 10 that relay-transports the package. Specific examples related to setting of the receiving location will be described later.

The generation unit 333 according to the present embodiment generates delivery instruction information based on the receiving location set by the setting unit 331. While specific examples of delivery instruction information will be described later, the delivery instruction information includes, for example, information regarding the receiving location set by the setting unit 331.

### <1.4. Example of Functional Configuration of Schedule Management Server 40>

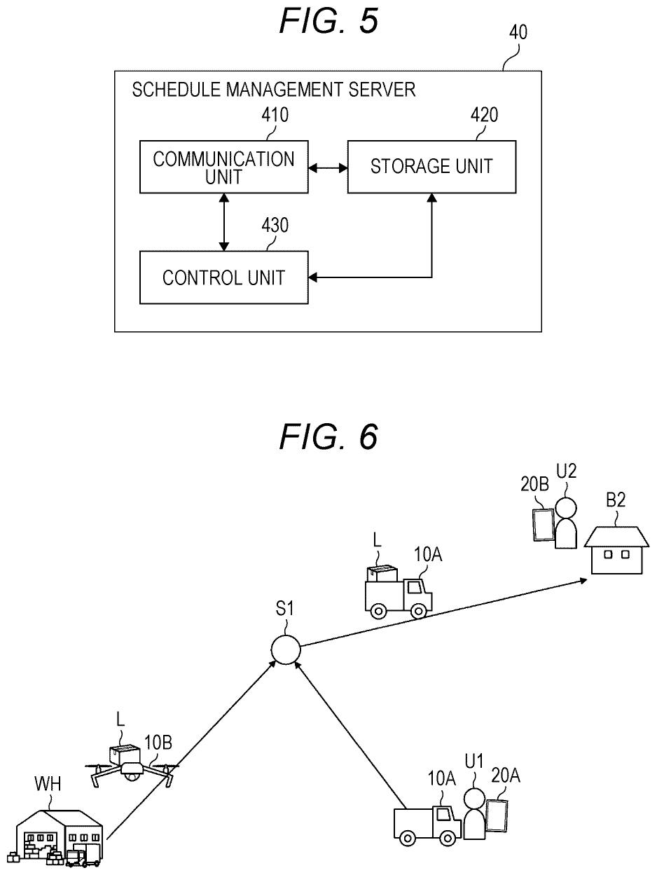

FIG. 5 is an explanatory diagram for describing an example of the functional configuration of the schedule management server 40 according to the present embodiment.

The schedule management server 40 according to the present embodiment includes a communication unit 410, a storage unit 420, and a control unit 430, as illustrated in FIG. 5.

### (Communication Unit 410)

The communication unit 410 according to the present embodiment performs various kinds of communication with the information terminal 20 and the operation management server 30. For example, the communication unit 410 may transmit location information related to the delivery person to the operation management server 30.

For example, the communication unit 410 may receive, from the delivery person terminal 20A, information regarding the receiving location or information regarding the collection location indicating the location designated by the client as the receiving location or the collection location of the package. In this case, the communication unit 410 may transmit, to the operation management server 30, location information related to the delivery person who is in charge of the delivery in the delivery area that includes the designated receiving location or collection location.

For example, the communication unit 410 may transmit, to the operation management server 30, information regarding the delivery route of the delivery person or the next location where the delivery person is scheduled to go for delivery or collection as the location information related to the delivery person.

### (Storage Unit 420)

The storage unit 420 according to the present embodiment holds software and various kinds of data. For example, the storage unit 420 holds delivery plans of each delivery person and delivery plans of the unmanned vehicle 10B. For example, a delivery plan includes various kinds of information such as location information regarding the delivery route of the delivery person and scheduled delivery locations of the delivery person, location information regarding each of a plurality of relay locations, the package loading status of each delivery slot of the manned mobile body 10A used by the delivery person for delivery, the availability of the unmanned vehicle 10B, and the like.

### (Control Unit 430)

The control unit 430 according to the present embodiment controls the overall operation of the schedule management server 40. For example, the control unit 430 may control the communication unit 410 to transmit the location information related to the delivery person.

For example, when a certain relay location is designated by the delivery person as the receiving location of a package, the control unit 430 may control the communication unit 410 to transmit the location information regarding the designated relay location to the operation management server 30 as the location information related to the delivery person.

The examples of the functional configurations of the information terminal 20, the operation management server 30, and the schedule management server 40 according to the present embodiment are described heretofore. Referring now to FIG. 6 to FIG. 9, specific examples related to setting of package receiving locations will be described.

### 2. Specific Examples Regarding Setting of Package Receiving Location

When a client requests delivery or collection of a package such as food or daily necessities through an application or a browser, a delivery person may be assigned to handle the delivery request for the package.

For example, a delivery person who responds to a delivery request of a package requested by a client needs to go to the warehouse or the store where the package is stored to collect the package as necessary. As a result, when the location where the package is to be collected is far from the location where the delivery person is at, it is necessary to travel a long distance to collect the package, thereby reducing the delivery efficiency of the delivery person.

Furthermore, a delivery request of a client may include a variety of demands. For example, a delivery request may include various kinds of demands such as a delivery slot, a package receiving location, and the like. The delivery request can also include a prescribed demand such as immediate delivery of a package (for example, food and the like).

When such a prescribed demand is included, the delivery plan of the delivery person may be affected since there is necessity to go to the warehouse or the store where the package is stored to collect the package as soon as it is determined that the delivery person is to handle the delivery of the package. In other words, when the delivery person responds to such irregular request as necessary, the delivery efficiency of the delivery person may be reduced.

For example, in order to lighten such burden on the delivery person and to suppress reduction in the delivery efficiency, it may be desirable for a package requested to be delivered to a client to be relay-transported by another mobile body from the warehouse or the store where the package is stored.

Thus, the information processing system according to the present embodiment acquires location information related to the delivery person and, based on the location information, sets a receiving location that indicates a location where the delivery person receives a package from the mobile body 10 that relay-transports the package. First, referring to FIG. 6, an overview related to delivering a package will be described.

FIG. 6 is an explanatory diagram for describing an overview related to package delivery. In the examples illustrated in FIG. 6 to FIG. 9, the package L is illustrated by being exposed to the outside the mobile bodies 10 for convenience of explanation. However, the package L may be stored inside the mobile bodies 10. The unmanned vehicle 10B may also have a structure to grasp the package L.

First, the client U2 requests delivery of the package L using the client terminal 20B. At this time, the client U2 designates the receiving location of the package L (for example, the receiving location such as home B2 of the client U2, a store or dedicated delivery facility near the home B2, as illustrated in FIG. 6). Then, the delivery person U1 is assigned by the schedule management server 40 for handling the delivery of the package L of the client U2.

For example, as the delivery person U1 for handling the delivery, a delivery person whose delivery route or delivery area included in the delivery plan covers the receiving location such as the home B2 of the client U2 or the like or a delivery person using the manned mobile body 10A (for example, a truck or the like) that has an available space in the housing state may be assigned.

Then, the communication unit 310 provided to the operation management server 30 may receive the location information related to the delivery person U1 who is handling the delivery from the delivery person terminal 20A or the schedule management server 40. The setting unit 331 may then set the receiving location (for example, a relay location S1 as illustrated in FIG. 6) based on the received location information related to the delivery person Ul.

Then, the generation unit 333 may generate delivery instruction information based on the set receiving location, and the communication unit 310 may transmit the generated delivery instruction information to the unmanned vehicle 10B that relay-transports the package L and the delivery person terminal 20A used by the delivery person U1.

This enables the unmanned vehicle 10B to relay-transport the package L from the warehouse WH where the package L requested to be delivered by the client U2 is stored, and to hand over the package L to the delivery person U1 at the set relay location S1.

Upon receiving the package L, the delivery person U1 delivers the package L to the receiving location such as the home B2 or the like designated by the client U2 as the receiving location. The delivery person U1 may use, as illustrated in FIG. 6, the manned mobile body 10A to deliver the package L, or may deliver the package L on foot.

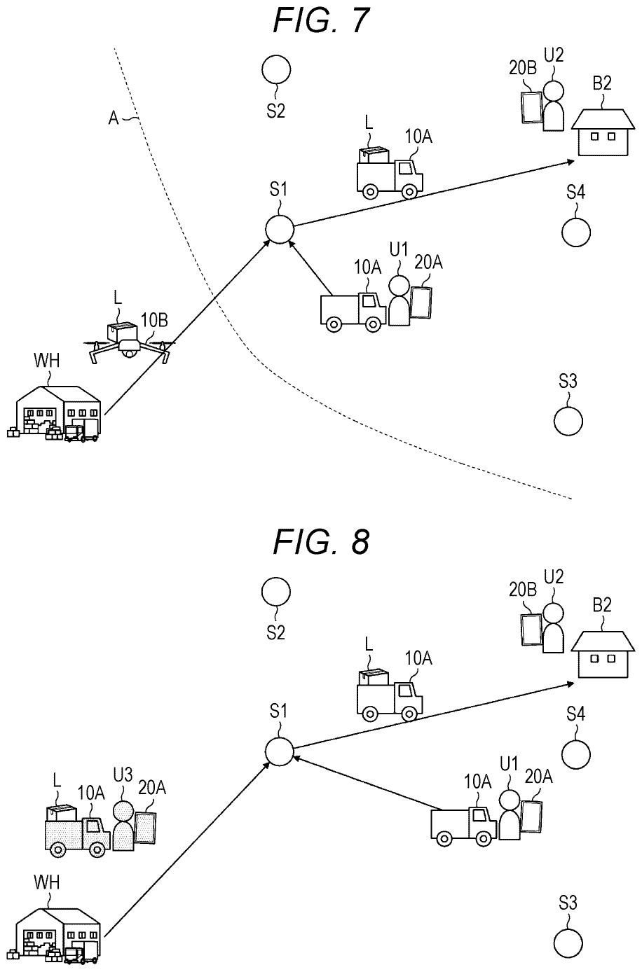

The overview related to package delivery is described heretofore. Referring now to FIG. 7 to FIG. 9, specific examples related to setting of the receiving locations of the package L will be described.

FIG. 7 is an explanatory diagram for describing an example related to setting of package receiving locations. In the example illustrated in FIG. 7, a case will be described in which a delivery area A is designated for the delivery person U1 as the area to be in charge of delivering the package L. In the examples illustrated in FIG. 7, inside the delivery area A of the delivery person Ul is the right side of the dashed line that indicates the boundary of the delivery area A, and outside the delivery area A is the left side of the dashed line that indicates the boundary of the delivery area A.

For example, a plurality of relay locations S1 to S4 are within the delivery area A of the delivery person U1. For example, the relay locations S1 to S4 may be, but not limited to, the locations of stands where the unmanned vehicle 10B can be on standby. The relay locations S1 to S4 may be any meeting locations, for example. However, it is desirable to be a location serving as landmark such as a bus stop, a building, or a parking lot, for example.

The setting unit 331 may set one relay location among the relay locations S1 to S4 as the receiving location, for example.

For example, the communication unit 410 receives location information indicating the location of the delivery person terminal 20A as the location of the delivery person U1 from the delivery person terminal 20A. Then, the setting unit 331 may set, as the receiving location, the relay location that satisfies a prescribed condition with respect to the location of the delivery person U1 acquired from the delivery person terminal 20A.

More specifically, the setting unit 331 may set, as the receiving location, the relay location S1 that is closest from the location of the delivery person Ul among the relay locations S1 to S4, for example. In the present specification, a case in which the relay location that satisfies the prescribed condition is the closest relay location is mainly described as an example. However, it is not limited thereto. A relay location that satisfies the prescribed condition may also be a relay location that satisfies other conditions, such as the second closest relay location or the like, for example.

Then, the generation unit 333 may generate delivery instruction information based on the set receiving location. For example, the delivery instruction information may include information regarding the delivery start location (for example, location of the warehouse WH where the package L is stored) and the receiving location, or may include information regarding the delivery route, the via point, and the like. The delivery instruction information may also include, for example, various kinds of information used for autonomous control of the unmanned vehicle 10B and for remote control of the unmanned vehicle 10B.

Then, the communication unit 310 may transmit the delivery instruction information generated by the generation unit 333 to an external device. For example, the external device may include the unmanned vehicle 10B that relay-transports the package L, the information terminal 20 used by the administrator who manages the unmanned vehicle, and the delivery person terminal 20A used by the delivery person U1 who delivers the package L.

For example, when the communication unit 310 transmits delivery instruction information to the unmanned vehicle 10B, the unmanned vehicle 10B upon receiving the delivery instruction information can deliver the package L by autonomous control from the warehouse WH to the relay location S1 as the receiving location.

Furthermore, when the communication unit 310 transmits delivery instruction information to the information terminal 20 used by the administrator who manages the unmanned vehicle 10B, the administrator may remotely operate the unmanned vehicle 10B based on the delivery instruction information, or may transmit the delivery instruction information to the unmanned vehicle 10B by using the information terminal 20 that is used by the administrator.

Furthermore, when the communication unit 310 transmits the delivery instruction information to the delivery person terminal 20A used by the delivery person U1 who delivers the package L, the delivery person U1 can check the relay location S1 where the package can be received from the unmanned vehicle 10B.

Note that the unmanned vehicle 10B may be on standby at the relay location S1 until the delivery person Ul arrives at the relay location S1. The unmanned vehicle 10B may also drop the package at the relay location S1 and return to the warehouse WH as the base without waiting for the delivery person Ul to arrive at the relay location S1. Furthermore, when there is a storage box placed at the relay location S1, for example, the unmanned vehicle 10B may also place the package L in the storage box and return to the warehouse WH. Also, when the delivery person U1 receives the package from the standby unmanned vehicle 10B or the storage box, delivery authentication may be performed using prescribed identification information.

Note that the location information related to the delivery person U1 is not limited to the location of the delivery person U1. The communication unit 410 may receive, from the schedule management server 40, route information including the delivery route of the delivery person U1 as the location information related to the delivery person U1. In this case, the setting unit 331 may set the receiving location based on the delivery route of the delivery person U1.

More specifically, the setting unit 331 may estimate the location of the delivery person Ul based on the delivery route of the delivery person Ul and the current time. The setting unit 331 may then set the relay location closest to the estimated location of the delivery person U1 as the receiving location.

The setting unit 331 may also set the receiving location according to the time based on the travel speed of the unmanned vehicle 10B and the distance of the relay transportation. For example, the setting unit 331 may estimate the assumed location of the delivery person U1 after the relay transportation, based on the time required for relay-transporting the package L by the unmanned vehicle 10B and the delivery route of the delivery person U1. The setting unit 331 may then set, as the receiving location, the relay location closest to the assumed location of the delivery person Ul after the relay transportation.

Furthermore, the communication unit 310 may receive, from the schedule management server 40, information regarding the next scheduled delivery location of the delivery person Ul as the location information related to the delivery person U1. In this case, the setting unit 331 may set, as the receiving location, the relay location (for example, the closest relay location) that satisfies a prescribed condition with respect to the next scheduled delivery location of the delivery person Ul.

The communication unit 310 may also receive, from the delivery person terminal 20A, designation information regarding the relay location designated by the delivery person U1. The setting unit 331 may then set the relay location designated by the delivery person U1 as the receiving location.

For example, the delivery person U1 may designate the relay location S4 as the receiving location. Then, the delivery person terminal 20A transmits the designation information regarding the relay location S4 designated by the delivery person U1 to the operation management server 30. The setting unit 331 may then set the relay location S4 included in the designation information as the receiving location. Note that the designation information may be transmitted from the schedule management server 40 to the operation management server 30 via the schedule management server 40.

Note that the receiving location of the package L for the client U2 is not limited to a building such as the home B2 or facility. For example, the relay locations S1 to S4 may be designated as the receiving location of the package L for the client U2. For example, the client U2 may request delivery by designating the relay location S4 that is the nearest bus stop as the receiving location of the package L. This allows the client to collect the package L at the nearest bus stop or the like, for example, which makes it possible to further improve the convenience for the client.

According to the setting of the package receiving locations as described above, the unmanned vehicle 10B assists delivery of the package for a delivery request demanding delivery to other areas not included in the delivery area A (for example, exclaves indicating places that are distant or geographically isolated, and the like). As a result, the delivery person Ul can focus on the deliveries within the delivery area A, which makes it possible to further improve the delivery efficiency of the delivery person U1.

Furthermore, there may be a case where the delivery plan of the delivery person U1 does not include a schedule to deliver or collect other packages in the neighborhood of the receiving location of the package L that is newly requested to be delivered. In such a case, the delivery person U1 may need to go to the receiving location only for the package I newly requested to be delivered. In the meantime, with the above-described setting of the package receiving locations, it is possible to reduce the time and effort required for the delivery person U1, and to further improve the delivery efficiency of the delivery person U1.

While an example where the unmanned vehicle 10B relay-transports the package L is described in FIG. 7, another delivery person U3 may relay-transport the package L, for example.

FIG. 8 is an explanatory diagram for describing an example of a case where the other delivery person U3 relay-transports the package L. For example, when the other delivery person U3 relay-transports the package L, the setting unit 331 may, for example, set the intermediate point between the delivery person U1 and another delivery person U3 as the receiving location. More specifically, the setting unit 331 may calculate the intermediate point based on the location of the delivery person U1 (for example, longitude and latitude) and the location of the other delivery person U3 (for example, longitude and latitude), and set the intermediate point as the receiving location.

The setting unit 331 may set the relay location S1 that is closest to the intermediate point between the delivery person U1 and the other delivery person U3 as the receiving location.

The setting unit 331 may also set the receiving location according to the types of the mobile bodies 10 used by each of the delivery person U1 and the other delivery person U3. For example, when the speed of the manned mobile body 10A used by the other delivery person U3 is faster than that of the manned mobile body 10A used by the delivery person U1, the setting unit 331 may set, as the receiving location, the relay location closer to the location of the delivery person U1 who has the slower travel speed.

Furthermore, a plurality of packages L may be relay-transported by a combination of the unmanned vehicle 10B and the other delivery person U3.

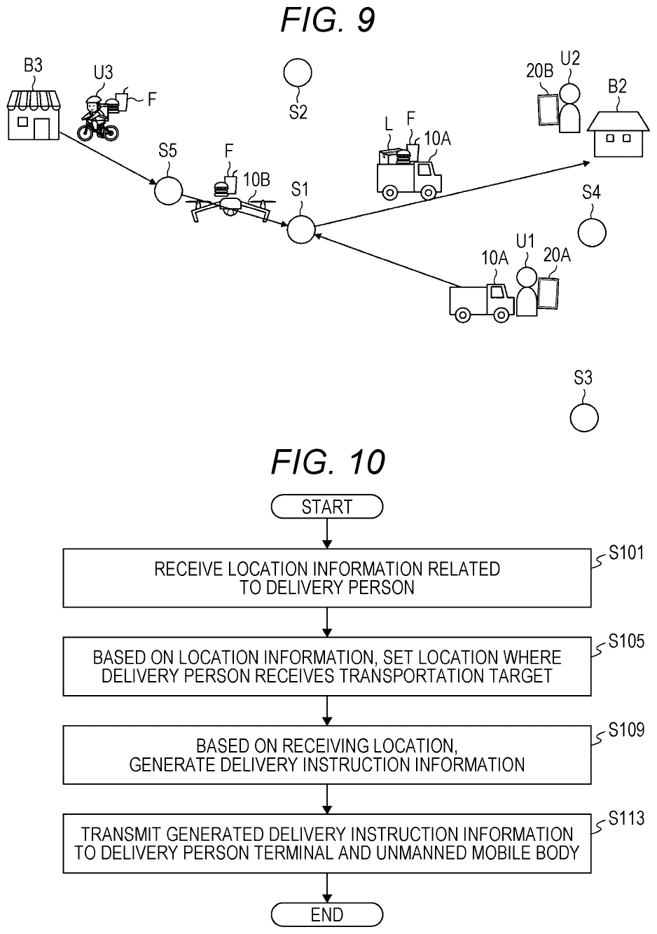

FIG. 9 is an explanatory diagram for describing another example of a case where the unmanned vehicle 10B and another delivery person U3 relay-transport the package L. For example, the client U2 requests delivery of food F using the client terminal 20B. At this time, the other delivery person U3 such as a store clerk at a store B3 or gig worker collects the food F at the store B3 and delivers it to a relay location S5. Note here that the unmanned vehicle 10B is on standby at the relay location S5 because it is the base of the unmanned vehicle 10B or because of the delivery of another package.

The other delivery person U3 may hand over the food F to the unmanned vehicle 10B at the relay location S5. The unmanned vehicle 10B may then travel to the relay location S1 that is the receiving location set by the setting unit 331.

By the combination of the other delivery person U3 and the unmanned vehicle 10B as described above, the delivery efficiency related to the delivery of the package L can be further improved. This may also lead to providing new job opportunities, when other delivery persons are service providers such as gig workers or store clerks.

It is assumed that there may be a plurality of candidates for the package delivery start location. In such a case, the setting unit 331 may designate one delivery start location among a plurality of delivery start candidates.

For example, when a client requests delivery of certain food, there may be a plurality of stores that handle the food. In this case, the setting unit 331 may designate, as a food delivery start location, a store where the distance between the location of each of the stores and the location of the delivery person is the shortest or a store where the delivery time for the location of the delivery vehicle is the shortest.

Specific examples regarding setting of the package receiving locations are described heretofore. Referring now to FIG. 10, an example of operation processing of the operation management server 30 according to the present embodiment will be described.

### 3. Operation Processing Example

FIG. 10 is an explanatory diagram for describing an example of the operation processing of the operation management server 30 according to the present embodiment. First, the communication unit 310 receives location information related to the delivery person (S101).

Then, the setting unit 331 sets the location where the delivery person receives the package based on the received location information related to the delivery person (S105).

The generation unit 333 then generates delivery instruction information based on the set receiving location (S109).

The communication unit 310 then transmits the generated delivery instruction information to the delivery person terminal 20A and the unmanned vehicle 10B as the external devices (S113), and the operation management server 30 according to the present embodiment ends the operation processing.

### 4. Hardware Configuration Example

The information processing described above is achieved through cooperation of software and hardware of the operation management server 30 described below. Note that the hardware configuration described below is also applicable to the information terminal 20 and the schedule management server 40.

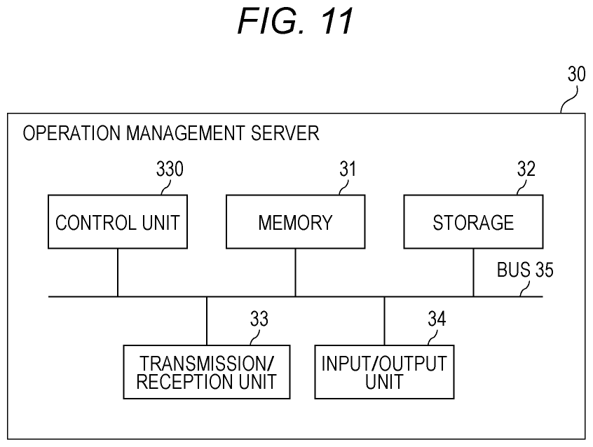

FIG. 11 is an explanatory diagram for describing an example of the hardware configuration of the operation management server 30 according to the present embodiment. As illustrated in FIG. 11, for example, the operation management server 30 includes a control unit 330, a memory 31, a storage 32, a transmission/reception unit 33, an input/output unit 34, and the like, which are electrically connected to each other via a bus 35.

The control unit 330 is an arithmetic device that controls the overall operation of the operation management server 30, controls transmission and reception of data between each of the elements, executes applications, and performs information processing and the like necessary for authentication processing. For example, the control unit 330 is a central processing unit (CPU) and/or a graphics processing unit (GPU), which executes programs and the like for the system stored in the storage 32 and expanded on the memory 31 to perform various kinds of information processing as described above.

The memory 31 includes a main memory that is configured with a volatile storage device such as dynamic random access memory (DRAM) or the like, and an auxiliary memory that is configured with a non-volatile storage device such as a flash memory, a hard disc drive (HDD), or the like. The memory 31 is used as a work area and the like of the control unit 330, and also stores the basic input/output system (BIOS) executed when starting the operation management server 30 as well as various kinds of setting information and the like.

The storage 32 stores various kinds of programs such as application programs and the like. A database that stores the data used for each kinds of processing may be built in the storage 32.

The transmission/reception unit 33 connects the operation management server 30 to the network and/or blockchain network. Note that the transmission/reception unit 33 may include near field communication interfaces of Bluetooth (registered trademark) and Bluetooth Low Energy (BLE).

The input/output unit 34 is an information input device such as a keyboard, a microphone, a mouse, and the like and an output device such as a display, a speaker, and the like.

The bus 35 is commonly connected to each of the above elements and transmits, for example, address signals, data signals, and various kinds of control signals.

### 5. Supplement

The preferable embodiment of the present invention is described above in detail with reference to the accompanying drawings. However, the present invention is not limited to such examples. It is readily apparent to those having ordinary knowledge and skilled in the art to which the present invention belongs that various modifications and substitutions can be made without departing from the technical spirit and scope of the appended claims, and that those naturally fall within the technical scope of the present invention.

For example, while the present specification mainly describes an example in which a delivery person uses the mobile body 10 to deliver the package, the delivery person does not necessarily need to use the mobile body 10. For example, the delivery person may deliver the package on foot.

The setting unit 331 may also set the receiving location indicating the location where the delivery person receives the package, based on various kinds of information such as delivery person information, store information, information regarding the products, and the like held at the storage unit 320. For example, when a controlled temperature zone of the package requested to be delivered by a client is the frozen zone, long-distance relay transportation by the unmanned vehicle 10B may be difficult. Thus, the setting unit 331 may set the relay location close to the unmanned vehicle 10B as the receiving location.

Also, the operation management server 30 may not necessarily need to transmit delivery instruction information and notification information to the external device. For example, in a case where the operation management server 30 includes a display unit, delivery instruction information and notification information may be displayed on the display unit. Then, for example, the administrator upon checking the delivery instruction information displayed on the display unit may instruct the delivery person U1 or the unmanned vehicle 10B to make the delivery using an arbitrary method.

Furthermore, the operation management server 30 according to the present embodiment may include some or all of the functional configuration of the schedule management server 40. When the operation management server 30 has all the functional configuration of the schedule management server 40, the information processing system according to the present embodiment may not need to include the schedule management server 40. Note that the schedule management server 40 may include some or all of the functional configuration of the operation management server 30.

It is also possible to create a computer program for causing hardware such as a CPU, a ROM, a RAM, and the like built into the information terminal 20, the operation management server 30, and the schedule management server 40 to achieve the same functions as those of the information terminal 20, the operation management server 30, and the schedule management server 40 described above.

### REFERENCE SIGNS LIST

10 Mobile body
20 Information terminal
210 Communication unit
230 Control unit
240 Operation display unit
30 Operation management server
310 Communication unit
320 Storage unit
330 Control unit
331 Setting unit
333 Generation unit
40 Schedule management server
410 Communication unit
420 Storage unit
430 Control unit

1. An information processing system comprising:
an acquisition unit that acquires location information related to a delivery person; and
a setting unit that sets, based on the location information acquired by the acquisition unit, a receiving location indicating a location where the delivery person receives a transportation target from a first mobile body that relay-transports the transportation target.

2. The information processing system according to claim 1, wherein the transportation target is delivered by the delivery person using a second mobile body.

3. The information processing system according to claim 1, wherein
a delivery area of the delivery person includes a plurality of relay locations, and
the setting unit sets one relay location among the relay locations as the receiving location.

4. The information processing system according to claim 3, wherein
the location information includes a location of the delivery person, and
the setting unit sets, as the receiving location, a relay location that satisfies a prescribed condition with respect to the location of the delivery person.

5. The information processing system according to claim 4, wherein the setting unit sets the receiving location based on the location of the delivery person and a delivery route of the delivery person.

6. The information processing system according to claim 1, wherein
the location information includes a next scheduled delivery location of the delivery person, and
the setting unit sets, as the receiving location, a relay location that satisfies a prescribed condition with respect to the next schedule delivery location of the delivery person.

7. The information processing system according to claim wherein
the location information includes a relay location designated by the delivery person, and
the setting unit sets, as the receiving location, the relay location designated by the delivery person.

8. The information processing system according to claim 6, wherein the relay location that satisfies the prescribed condition includes a closest relay location.

9. The information processing system according to claim 2, wherein the first mobile body includes a vehicle or an aircraft.

10. The information processing system according to claim 9, wherein the first mobile body includes a vehicle that is used by another delivery person.

11. The information processing system according to claim 10, wherein the second mobile body includes a vehicle.

12. The information processing system according to claim 10, wherein the setting unit sets, as the receiving location, an intermediate point between the delivery person and the other delivery person.

13. The information processing system according to claim 10, wherein the setting unit sets, as the receiving location, a relay location closest to an intermediate point.

14. The information processing system according to claim 10, wherein the setting unit sets the receiving location in accordance with types of mobile bodies used by the delivery person and the other delivery person.

15. The information processing system according to claim 1, further comprising a generation unit that generates delivery instruction information based on the receiving location set by the setting unit.

16. The information processing system according to claim 15, further comprising a communication unit that transmits the delivery instruction information generated by the generation unit to an external device.

17. The information processing system according to claim 16, wherein, when a prescribed demand is included in request details included in a delivery request of the transportation target, the communication unit transmits notification information corresponding to the prescribed demand to a terminal used by the delivery person.

18. An information processing device comprising:
an acquisition unit that acquires location information related to a delivery person; and
a setting unit that sets, based on the location information acquired by the acquisition unit, a receiving location indicating a location where the delivery person receives a transportation target from a first mobile body that relay-transports the transportation target.

19. An information processing method executed by a computer, the information processing method comprising:
acquiring location information related to a delivery person; and
setting, based on the acquired location information, a receiving location indicating a location where the delivery person receives a transportation target from a first mobile body that relay-transports the transportation target.

20. A program causing a computer to execute:
an acquisition function that acquires location information related to a delivery person; and
a setting function that sets, based on the location information acquired by the acquisition function, a receiving location indicating a location where the delivery person receives a transportation target from a first mobile body that relay-transports the transportation target.
